(19) United States
(12) Patent Application Publication
(10) Pub. No.: US 2026/0371312 A1
(43) Pub. Date: Nov. 19, 2026

(54) PAGING MONITORING IN WIRELESS COMMUNICATIONS

(71) Applicant: LG Electronics Inc., Seoul (KR)

(72) Inventors: Sunghoon JUNG, Seoul (KR); Sangwon KIM, Seoul (KR)

(21) Appl. No.: 19/142,600

(22) PCT Filed: Jan. 7, 2025
(86) PCT No.: PCT/KR2025/000338

§ 371 Date: Jun. 23, 2025

Related U.S. Application Data
(60) Provisional application No. 63/618,877, filed on Jan. 8, 2024.

(51) Int. Cl. H04W 68/02; H04W 76/27

(52) U.S. Cl. CPC H04W 68/02; H04W 76/27

(57) ABSTRACT

The present disclosure is related to paging monitoring in wireless communications. According to an embodiment of the present disclosure, a method performed by a communication device comprises: receiving information for a first paging occasion, and information for at least one second paging occasion related to the first paging occasion; monitoring a paging in the first paging occasion; based on detecting the paging in the first paging occasion, receiving a first paging message comprising first information, and monitoring a paging in the at least one second paging occasion; based on detecting the paging in the at least one second paging occasion, receiving a second paging message comprising second information; and determining whether a communication device is paged based on the first information and the second information.

### TECHNICAL FIELD

The present disclosure is related to paging monitoring in wireless communications.

### BACKGROUND ART

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a communication device may need to monitor a paging to receive data from a network and/or establish a connection with the network.

### DISCLOSURE OF INVENTION

### Solution to Problem

An aspect of the present disclosure is to provide method and apparatus for paging monitoring in a wireless communication system.

According to an embodiment of the present disclosure, a method performed by a communication device comprises: receiving information for a first paging occasion, and information for at least one second paging occasion related to the first paging occasion; monitoring a paging in the first paging occasion; based on detecting the paging in the first paging occasion, receiving a first paging message comprising first information, and monitoring a paging in the at least one second paging occasion; based on detecting the paging in the at least one second paging occasion, receiving a second paging message comprising second information; and determining whether a communication device is paged based on the first information and the second information.

According to an embodiment of the present disclosure, a method performed by a network node comprises: transmitting, to a communication device, information for a first paging occasion, and information for at least one second paging occasion related to the first paging occasion; transmitting a paging in the first paging occasion and a first paging message comprising first information; and transmitting a paging in the at least one second paging occasion and a second paging message comprising second information, wherein the communication device is configured to perform operations comprising: monitoring the paging in the first paging occasion; based on detecting the paging in the first paging occasion, receiving the first paging message comprising the first information and monitoring the paging in the at least one second paging occasion; based on detecting the paging in the at least one second paging occasion, receiving the second paging message comprising the second information; and determining whether the communication device is paged based on the first information and the second information.

According to various embodiments, apparatuses to implement the above methods are provided.

The present disclosure may have various advantageous effects.

For example, the size of available paging ID can be extended. This would reduce paging false alarm as well as the need of reading MR-paging message, thereby reducing UE power consumption.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a paging procedure according to an embodiment of the present disclosure.

FIG. 9 shows an example of WUR monitoring procedure according to an embodiment of the present disclosure.

FIG. 10 shows an example of MR power state transmission triggered by LP-WUS/WUR according to an embodiment of the present disclosure.

FIG. 11 shows an example of a method performed by a communication device for paging monitoring according to an embodiment of the present disclosure.

FIG. 12 shows an example of a signal flow between the communication device and a network node for paging monitoring according to an embodiment of the present disclosure.

FIG. 13 shows an example of scheduling of joint LR messages according to an embodiment of the present disclosure.

FIG. 14 shows an example of scheduling parameters for LR S-POs according to an embodiment of the present disclosure.

FIG. 15 shows an example of paging ID derivation based on multiple LR-paging message according to an embodiment of the present disclosure.

### MODE FOR THE INVENTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

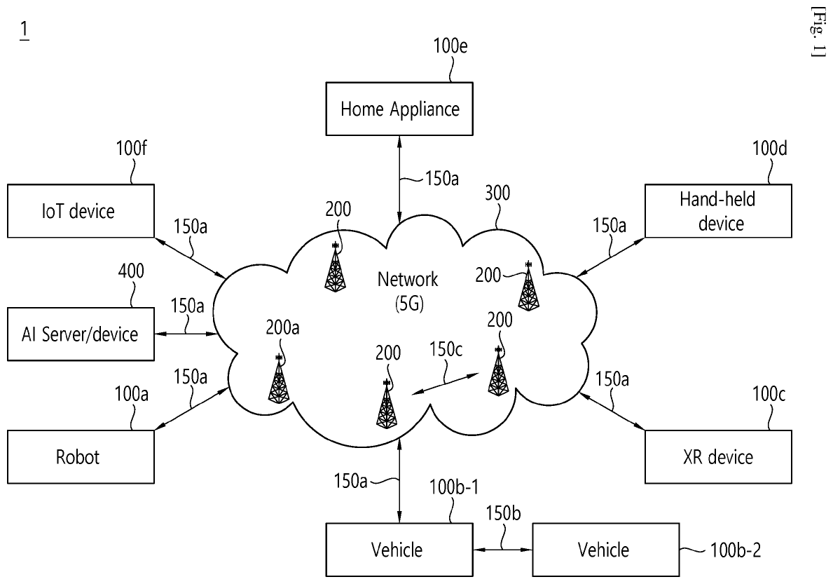

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding frequency | | |
|---|---|---|---|
| designation | range | Subcarrier Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

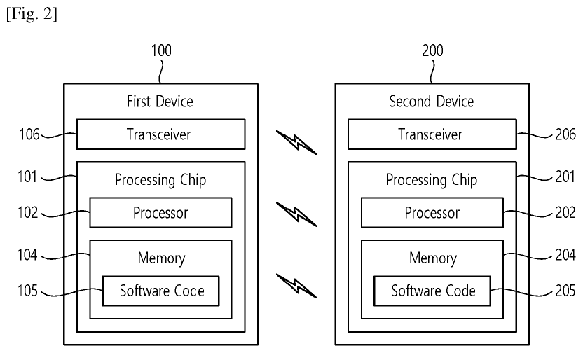

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104. The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

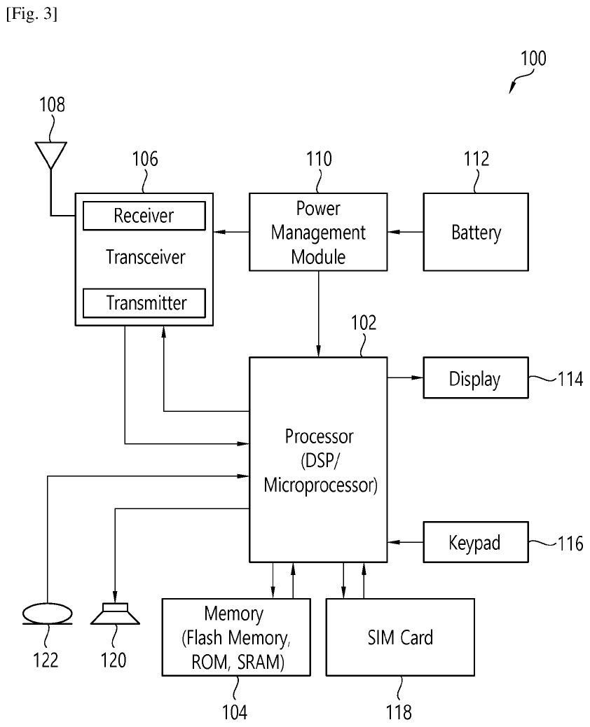

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

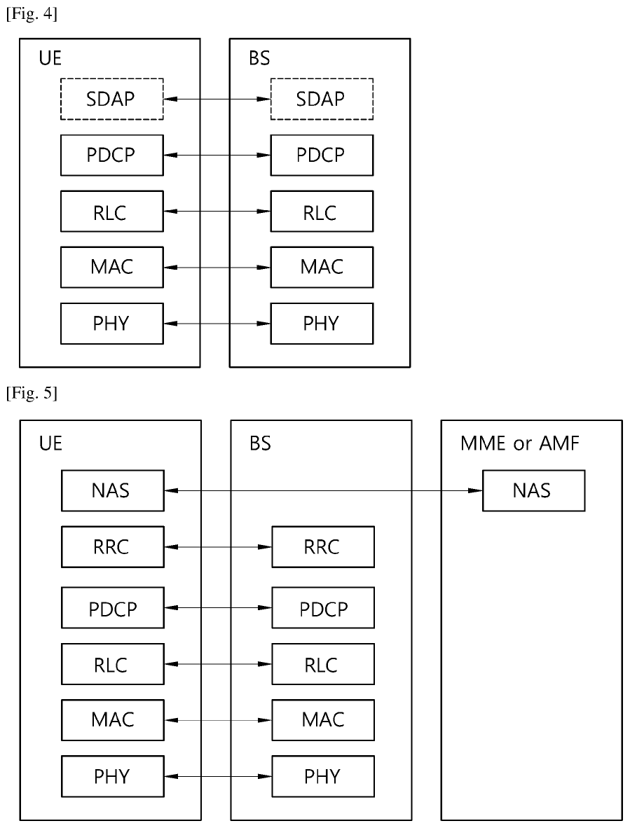

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (L1, for example PHY layer) and Layer 2 (L2, for example MAC/RLC/PDCP layer). Referring to FIG. 5, the control plane protocol stack may be divided into Layer 1 (L1, for example PHY layer), Layer 2 (L2, for example MAC/RLC/PDCP layer), Layer 3 (L3, for example an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

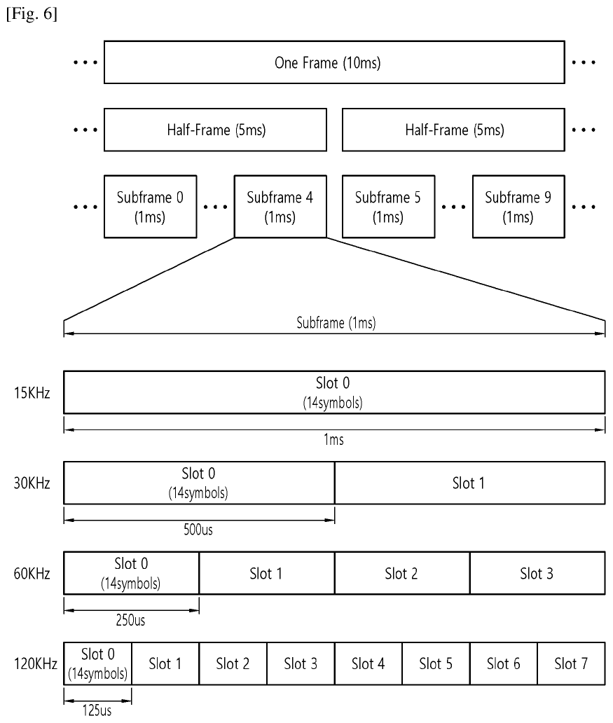

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2″*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}^{^{grid,x}}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 KHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: N_{PRB}=N_{CRB}+N^{size}_{BWP,i}, Where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

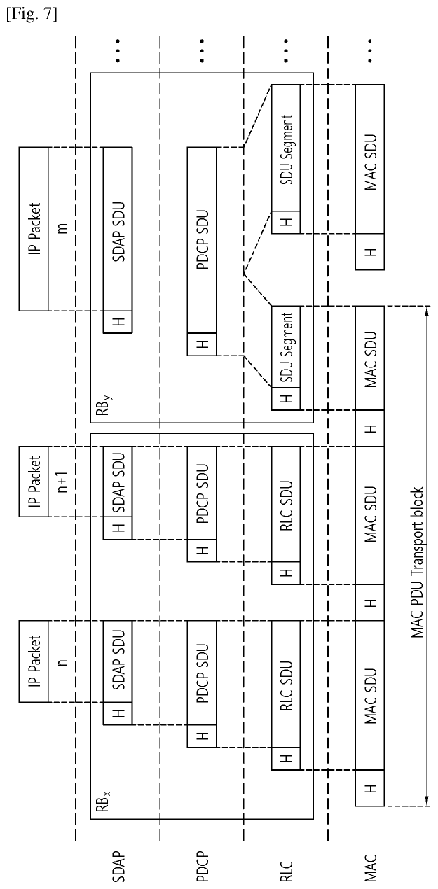

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and random access channel (RACH) are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, paging related features are described.

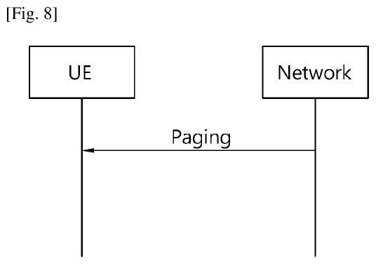

FIG. 8 shows an example of a paging procedure according to an embodiment of the present disclosure.

The purpose of the paging procedure is to transmit paging information to a UE in RRC_IDLE or RRC_INACTIVE, and/or to transmit paging information for a L2 U2N Remote UE in RRC_IDLE or RRC_INACTIVE to its serving L2 U2N Relay UE in any RRC state.

The network initiates the paging procedure by transmitting the Paging message at the UE's paging occasion. The network may address multiple UEs within a Paging message by including one PagingRecord for each UE. The network may also include one or multiple TMGI(s) in the Paging message to page UEs for specific MBS multicast session(s).

Upon receiving the Paging message by the UE or receiving PagingRecord from its connected L2 U2N Relay UE by a L2 U2N Remote UE, the UE shall:
1> if in RRC_IDLE, for each of the PagingRecord, if any, included in the Paging message, or
1> if in RRC_IDLE, for each of the PagingRecord, if any, included in the UuMessageTransferSidelink message received from the connected L2 U2N Relay UE:
2> if the ue-Identity included in the PagingRecord matches the UE identity allocated by upper layers:
3> if upper layers indicate the support of paging cause:
4> forward the ue-Identity, accessType (if present) and paging cause (if determined) to the upper layers;
3> else:
4> forward the ue-Identity and accessType (if present) to the upper layers;
1> if in RRC_INACTIVE, for each of the PagingRecord, if any, included in the Paging message, or
1> if in RRC_INACTIVE, for each of the PagingRecord, if any, included in the UuMessageTransferSidelink message received from the connected L2 U2N Relay UE:
2> if the ue-Identity included in the PagingRecord matches the UE's stored fullI-RNTI:
3> if the UE is configured by upper layers with Access Identity 1:
4> initiate the RRC connection resumption procedure with resumeCause set to mps-PriorityAccess;
3> else if the UE is configured by upper layers with Access Identity 2:
4> initiate the RRC connection resumption procedure with resumeCause set to mcs-PriorityAccess;
3> else if the UE is configured by upper layers with one or more Access Identities equal to 11-15:
4> initiate the RRC connection resumption procedure with resumeCause set to highPriorityAccess;
3> else:
4> initiate the RRC connection resumption procedure with resumeCause set to mt-Access;

A MUSIM UE may not initiate the RRC connection resumption procedure, e.g., when it decides not to respond to the Paging message due to UE implementation constraints.
2> else if the ue-Identity included in the PagingRecord matches the UE identity allocated by upper layers:
3> if upper layers indicate the support of paging cause:
4> forward the ue-Identity, accessType (if present) and paging cause (if determined) to the upper layers;
3> else:
4> forward the ue-Identity and accessType (if present) to the upper layers;
3> perform the actions upon going to RRC_IDLE with release cause ‘other’;
1> if in RRC_IDLE, for each TMGI included in pagingGroupList, if any, included in the Paging message:
2> if the UE has joined an MBS session indicated by the TMGI included in the pagingGroupList:
3> forward the TMGI to the upper layers;
1> if in RRC_INACTIVE and the UE has joined one or more MBS session(s) indicated by the TMGI(s) included in the paging GroupList:
2> if PagingRecordList is not included in the Paging message; or
2> if none of the ue-Identity included in any of the PagingRecord matches the UE identity allocated by upper layers or the UE's stored fullI-RNTI:
3> initiate the RRC connection resumption procedure with resumeCause set as below:
4> if the UE is configured by upper layers with Access Identity 1:
5> set resumeCause to mps-PriorityAccess;
4> else if the UE is configured by upper layers with Access Identity 2:
5> set resumeCause to mcs-PriorityAccess;
4> else if the UE is configured by upper layers with one or more Access Identities equal to 11-15:
5> set resumeCause to highPriorityAccess;
4> else:
5> set resumeCause to mt-Access;
2> else if the ue-Identity included in any of the PagingRecord matches the UE identity allocated by upper layers:
3> forward the TMGI(s) to the upper layers;
1> if the UE is acting as a L2 U2N Relay UE, for each of the PagingRecord, if any, included in the Paging message:
2> if the ue-Identity included in the PagingRecord in the Paging message matches the UE identity in sl-PagingIdentityRemoteUE included in sl-PagingInfo-RemoteUE received in RemoteUEInformationSidelink message from a L2 U2N Remote UE: 3> initiate the Uu Message transfer in sidelink to that UE;

The UE may use Discontinuous Reception (DRX) in RRC_IDLE and RRC_INACTIVE state in order to reduce power consumption. The UE monitors one paging occasion (PO) per DRX cycle. A PO is a set of PDCCH monitoring occasions and can consist of multiple time slots (e.g. subframe or OFDM symbol) where paging DCI can be sent. One Paging Frame (PF) is one Radio Frame and may contain one or multiple PO(s) or starting point of a PO. A L2 U2N Relay UE monitors the paging occasions of its PC5-RRC connected L2 U2N Remote UEs. In this case, the DRX cycle and UE ID mentioned in this clause refer to those of the L2 U2N Remote UE.

In multi-beam operations, the UE assumes that the same paging message and the same Short Message are repeated in all transmitted beams and thus the selection of the beam(s) for the reception of the paging message and Short Message is up to UE implementation. The paging message is same for both RAN initiated paging and CN initiated paging.

The UE initiates RRC Connection Resume procedure upon receiving RAN initiated paging. If the UE receives a CN initiated paging in RRC_INACTIVE state, the UE moves to RRC_IDLE and informs NAS. However, if a L2 U2N Relay UE in RRC_INACTIVE state receives a CN initiated paging for a L2 U2N Remote UE, the L2 U2N Relay UE does not move to RRC_IDLE state.

The L2 U2N Remote UE does not need to monitor the PO in order to receive the paging message.

While the SDT procedure is ongoing in RRC_INACTIVE state, the UE monitors the PO in order to receive only the Short Message as specified in TS 38.331 [3].

The PF and PO for paging are determined by the following formulae:

SFN for the PF is determined by (SFN+PF_offset)mod T=(T div N)*(UE_ID mod N); and

Index (i_s), indicating the index of the PO is determined by i_s=floor (UE_ID/N)mod Ns.

The PDCCH monitoring occasions for paging are determined according to pagingSearchSpace and firstPDCCH-MonitoringOccasionOfPO and nrofPDCCH-MonitoringOccasionPerSSB-InPO if configured. When SearchSpaceId=0 is configured for pagingSearchSpace, the PDCCH monitoring occasions for paging are same as for RMSI.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPe rSSB-InPO if configured or is equal to 1 otherwise. The [x*S+K]^{th} PDCCH monitoring occasion for paging in the PO corresponds to the Kth transmitted SSB, where x=0, 1, . . . , X−1, K=1, 2, . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)^{th} value of the firstPDCCH-MonitoringOccasionOfPO parameter; otherwise, it is equal to i_s*S*X. If X>1, when the UE detects a PDCCH transmission addressed to P-RNTI within its PO, the UE is not required to monitor the subsequent PDCCH monitoring occasions for this PO.

A PO associated with a PF may start in the PF or after the PF.

The PDCCH monitoring occasions for a PO can span multiple radio frames. When SearchSpaceId other than 0 is configured for paging-SearchSpace the PDCCH monitoring occasions for a PO can span multiple periods of the paging search space.

The following parameters are used for the calculation of PF and i_s above:
T: DRX cycle of the UE. If eDRX is not configured, T is determined by the shortest of the UE specific DRX value(s), if configured by RRC and/or upper layers or provided in PC5-RRC signalling in case of a L2 U2N Relay UE, and a default DRX value broadcast in system information;
N: number of total paging frames in T;
Ns: number of paging occasions for a PF;
PF_offset: offset used for PF determination;
UE_ID: 5G-S-TMSI mod 1024.

Parameters Ns, nAndPagingFrameOffset, nrofPDCCH-MonitoringOccasionPe rSSB-InPO, and the length of default DRX Cycle are signaled in SIB1. The values of N and PF_offset are derived from the parameter nAndPagingFrameOffset. The parameter firstPDCCH-MonitoringOccasionOfPO is signalled in SIB1 for paging in the BWP configured by initialDownlinkBWP. For paging in a DL BWP other than the BWP configured by initialDownlinkBWP, the parameter first-PDCCH-MonitoringOccasionOfPO is signaled in the corresponding BWP configuration.

If the UE has no 5G-S-TMSI, for instance when the UE has not yet registered onto the network, the UE shall use as default identity UE_ID=0 in the PF and i_s formulas above.

5G-S-TMSI is a 48 bit long bit string. 5G-S-TMSI shall in the formulae above be interpreted as a binary number where the left most bit represents the most significant bit.

In RRC_INACTIVE state, if the UE supports inactiveStatePO-Determination and the network broadcasts ranPagingInIdlePO with value “true”, the UE shall use the same i_s as for RRC_IDLE state. Otherwise, the UE determines the i_s based on the parameters and formula above.

In RRC_INACTIVE state, if eDRX value configured by upper layers is no longer than 1024 radio frames, the UE shall use the same i_s as for RRC_IDLE state.

In RRC_INACTIVE state, if eDRX value configured by upper layers is longer than 1024 radio frames, during CN PTW, the UE shall use the same i_s as for RRC_IDLE state.

The UE may use Paging Early Indication (PEI) in RRC_IDLE and RRC_INACTIVE states in order to reduce power consumption. If PEI configuration is provided in system information, the UE in RRC_IDLE or RRC_INACTIVE state supporting PEI (except for the UEs expecting MBS group notification) can monitor PEI using PEI parameters in system information according to the procedure described below.

If lastUsedCellOnly is configured in system information of a cell, the UE monitors PEI in this cell only if the UE most recently received RRCRelease without noLastCellUpdate in this cell. Otherwise (i.e., if lastUsedCellOnly is not configured in system information of a cell), the UE monitors PEI in the camped cell.

The UE monitors one PEI occasion per DRX cycle. A PEI occasion (PEI-O) is a set of PDCCH monitoring occasions (MOs) and can consist of multiple time slots (e.g. subframes or OFDM symbols) where PEI can be sent. In multi-beam operations, the UE assumes that the same PEI is repeated in all transmitted beams and thus the selection of the beam(s) for the reception of the PEI is up to UE implementation.

The time location of PEI-O for UE's PO is determined by a reference point and an offset:
The reference point is the start of a reference frame determined by a frame-level offset from the start of the first PF of the PF(s) associated with the PEI-O, provided by pei-FrameOffset in SIB1;
The offset is a symbol-level offset from the reference point to the start of the first PDCCH MO of this PEI-O, provided by firstPDCCH-MonitoringOccasionOfPEI-O in SIB1.

If one PEI-O is associated with POs of two PFs, the two PFs are consecutive PFs calculated by the parameters PF_offset, T, NS, and N. The first PF of the PFs associated with the PEI-O is provided by (SFN for PF)−floor (i_{PO}/Ns)*T/N.

The PDCCH MOs for PEI are determined according to pei-SearchSpace, pei-FrameOffset, firstPDCCH-MonitoringOccasionOfPEI-O and nrofPDCCH-MonitoringOccasionPerSSB-InPO if configured. When SearchSpaceId=0 is configured for pei-SearchSpace, the PDCCH MOs for PEI are same as for RMSI. UE determines first PDCCH MO for PEI-O based on pei-FrameOffset and firstPDCCH-MonitoringOccasionOfPEI-O, as for the case with SearchSpaceId>0 configured.

When SearchSpaceId=0 is configured for pei-SearchSpace, the UE monitors the PEI-O according to searchSpaceZero. When SearchSpaceId other than 0 is configured for pei-SearchSpace, the UE monitors the PEI-O according to the search space with the configured SearchSpaceId.

A PEI occasion is a set of ‘S*X’ consecutive PDCCH MOs, where ‘S’ is the number of actual transmitted SSBs determined according to ssb-PositionsInBurst in SIB1, and X is the nrofPDCCH-MonitoringOccasionPerSSB-InPO if configured or is equal to 1 otherwise. The [x*S+K]^{th} PDCCH MO for PEI in the PEI-O corresponds to the Kth transmitted SSB, where x=0, 1, . . . , X−1, K=1, 2, . . . , S. The PDCCH MOs for PEI which do not overlap with UL symbols (determined according to tdd-UL-DL-ConfigurationCommon) are sequentially numbered from zero starting from the first PDCCH MO for PEI in the PEI-O. When the UE detects a PEI within its PEI-O, the UE is not required to monitor the subsequent MO(s) associated with the same PEI-O.

If the UE detects PEI and the PEI indicates the subgroup the UE belongs to monitor its associated PO, the UE monitors the associated PO. If the UE does not detect PEI on the monitored PEI occasion or the PEI does not indicate the subgroup the UE belongs to monitor its associated PO, the UE is not required to monitor the associated PO.

If the UE is unable to monitor the PEI occasion (i.e., all valid PDCCH MO for PEI) corresponding to its PO, e.g., during cell re-selection, the UE monitors the associated PO.

In RRC_INACTIVE state, when the UE uses the same i-_s as for RRC_IDLE state, the UE shall use the same i_{PO} as for RRC_IDLE state. Otherwise, the UE determines the i_{PO} based on the formula.

If PEI and subgrouping are configured, UEs monitoring the same PO can be divided into one or more subgroups. With subgrouping, the UE monitors the associated PO if the corresponding bit for subgroup the UE belongs to is indicated as 1 by PEI corresponding to its PO.

The following parameters are used for the determination of subgroup ID:
subgroupsNumPerPO: total number of subgroups for both CN assigned subgrouping (if any) and UE_ID based subgrouping (if any) in a PO, which is broadcasted in system information;
subgroupsNumForUEID: number of subgroups for UE_ID based subgrouping in a PO, which is broadcasted in system information.

UE's subgroup can be either assigned by CN or formed based on UE_ID:
If subgroupsNumForUEID is absent in subgroupConfig, the subgroup ID based on CN assigned subgrouping, if available for the UE, is used in the cell.
If both subgroupsNumPerPO and subgroupsNumForUEID are configured, and subgroupsNumForUEID has the same value as subgroupsNumPerPO, the subgroup ID based on UE_ID based subgrouping is used in the cell.
If both subgroupsNumPerPO and subgroupsNumForUEID are configured, and subgroupsNumForUEID<subgroupsNumPerPO:
The subgroup ID based on CN assigned subgrouping, if available for the UE, is used in the cell;
Otherwise, the subgroup ID based on UE_ID based subgrouping is used in the cell.

If a UE has no CN assigned subgroup ID or does not support CN assigned subgrouping, and there is no configuration for subgroupsNumForUEID, the UE monitors the associated PO.

Paging with CN assigned subgrouping is used in the cell which supports CN assigned subgrouping. A UE supporting CN assigned subgrouping in RRC_IDLE or RRC_INACTIVE state can be assigned a subgroup ID (between 0 to 7) by AMF through NAS signalling. The UE belonging to the assigned subgroup ID monitors its associated PEI which indicates the paged subgroup(s).

Paging with UE_ID based subgrouping is used in the cell which supports UE_ID based subgrouping.

If the UE is not configured with a CN assigned subgroup ID, or if the UE configured with a CN assigned subgroup ID is in a cell supporting only UE_ID based subgrouping, the subgroup ID of the UE is determined by the formula below:

SubgroupID=(floor (UE_ID/(N*Ns)) mod subgroupsNumForUEID)+ (subgroupsNumPerPO-subgroupsNumForUEID), where:
N: number of total paging frames in T, which is the DRX cycle of RRC_IDLE state;
Ns: number of paging occasions for a PF;
UE_ID: 5G-S-TMSI mod X, where X is 32768, if eDRX is applied; otherwise, X is 8192; and
subgroupsNumForUEID: number of subgroups for UE_ID based subgrouping in a PO, which is broadcasted in system information

The UE belonging to the SubgroupID monitors its associated PEI which indicates the paged subgroup(s).

Hereinafter, contents regarding low-power wake-up signal (LP-WUS) and low-power wake-up receiver (LP-WUS) are described.

In wireless communications, increased performance and a wide range of services (e.g., ultra-reliable low-latency communications, URLLC) can be supported. For example, it is adopted a leaner signaling design, which limits the control overhead signaling in an unloaded network thus reducing the network energy consumption. Further, operation in a wider range of frequency bands can be supported, especially with adaption to work in higher frequency bands, e.g., mm-wave bands, with a significantly reduced latency. For a device, or user equipment (UE), operation in a wider bandwidth will give a higher achievable throughput. However, this is also more energy-consuming for the UE and can lead to shorter device battery life.

Several features have been introduced to reduce the device energy consumption and prolong battery life, e.g., bandwidth part (BWP) switching, monitoring of physical downlink control channel (PDCCH) in a narrower so-called control resource set (CORESET), and disabling secondary cells when not used. In general, monitoring PDCCH is the main contributor to the UE energy consumption, and reducing the PDCCH monitoring for the UE, in the time or frequency domain, is the key factor to achieving longer device battery life. To reduce the PDCCH monitoring time, a sequence-based wake-up signal (WUS, or low-power WUS (LP-WUS)) was introduced for low-power wide-area (LPWA) solutions narrow-band Internet of Things (NB-IoT). With this solution, the UE in the radio resource control (RRC) idle state only monitors the paging occasion (PO) if a WUS is first detected within a configured time offset before the PO. For these LPWA solutions, 20 dB coverage enhancement was introduced, mainly achieved by time repetition. The main motivation for the introduction of WUS was to reduce the monitoring time of the large number of PDCCH repetitions in the PO required for UEs in poor coverage in the case when there is no paging for the UE (which is most often the case).

To reduce the false paging, i.e., that the UE is unintentionally woken up by paging for another UE sharing the same PO, group WUS (GWUS) to include UE subgroups using multiple WUS sequences is introduced. According to GWUS, up to 8 UE subgroups per PO are supported. For RRC connected state, a downlink control information (DCI)-based WUS, referred to as DCP, was introduced. According to DCP, UE may perform a discontinuous reception (DRX) operation such that the UE only monitors PDCCH in the configured DRX on-duration window if first a PDCCH-based WUS is received within a fixed time offset before the DRX on-duration. If it is not, the UE can skip the entire on-duration and will thereby reduce the energy consumption. Further, paging early indication (PEI) was introduced. PEI is a WUS feature for RRC Idle and Inactive where the UE only wakes up to monitor PDCCH in the PO if the PDCCH-based WUS associated to the PO and monitored a time offset before the PO is received first. For PEI, UE subgrouping of up to 8 subgroups per PO was introduced and indicated by bits in the DCI.

DCP for RRC connected and PEI for RRC idle/inactive were mainly intended for mobile broadband (MBB) use cases and human-originated traffic. For WUS in general, the biggest gain can be achieved when relatively low downlink latency needs to be achieved while there is rarely anything to transmit to the UE. That is, if battery life is the only relevant performance metric, the UE can spend most of the time in a sleep state, e.g., using the extended DRX (eDRX) or Mobile Initiated Communication Only (MICO) features, yet, the drawback is that the downlink latency can be several hours long. Therefore, the benefit of WUS is that the UE power saving can be achieved without compromising the latency.

The UE power saving gain is primarily achieved by keeping the main receiver/main radio (MR) in a sleep state to conserve energy. If the MR does not have to be started every time the UE monitors WUS but can be kept in a sleep state, large UE power saving can be achieved compared to DRX/eDRX. Gains will therefore be bigger for more infrequent data transmissions, or less active traffic models, which is typically the case for IoT services, as opposed to the previous DCP and PEI features which are more focused on more active MBB use cases. To this end, a separate wake-up receiver (WUR, or low-power WUR (LP-WUR)) must be used.

### I. WUR Architecture

Among different receiver architectures, two common WUR architectures are: the direct demodulation approach, also known as radio frequency (RF) envelope detector (ED), and the on-chip local oscillator (LO) approach. The first type of architecture is characterized by low complexity, low cost, and extremely low energy consumption since no active RF circuits are typically used. In contrast, the second type of architecture requires more complex components, like on-chip local oscillators that down-convert the incoming RF signal to baseband (BB) or intermediate frequency (IF). This results in higher energy consumption relative to the ED, but the architecture can offer better sensitivity and robustness to interferers thanks to the possibility of implementing sharp BB/IF filters. In the on-chip LO Zero-IF architecture, also known as a homodyne receiver, the incoming RF signal is directly down-converted to BB.

Another candidate WUR architecture may be the orthogonal frequency division multiplexing (OFDM) WUR architecture. Even though an OFDM-capable architecture is more complex and more power-hungry than the simpler Zero IF architecture described above, it can bring some advantages. For instance, such WUR would be capable of in-phase and quadrature (I/Q) sampling and measurements from existing NR signals, thus allowing less frequent wake-up of the MR, which significantly can reduce the energy consumption.

### II. WUS Design

To ensure that the WUR can detect the WUS and perform necessary functionalities, the signal design needs to consider the receiver architecture, performance requirements as well as network and coexistence impacts. The key design principles are as follows: 1) it should be possible to multiplex the WUS with other transmissions in time or frequency domain without causing interference and 2) it should be possible to generate the WUS with the hardware of the base station (e.g., gNB) transmitter without creating new emissions/compliance requirements. The signal design involves determining a suitable modulation and coding scheme, signal structure, payload, and time-frequency span of the signal. Regarding the WUS bandwidth, it is recommended a bandwidth less than or equal to 5 MHz for idle/inactive mode although other bandwidth sizes up to 20 MHz can be considered. Also, for multiplexing with other signals and channels, it is beneficial if WUS has a flexible frequency position such that it can be flexibly allocated within a carrier.

In terms of modulation, the two main candidates for WUS are OFDM-based WUS and on-off keying (OOK)-based WUS.

### (1) OFDM-Based WUS

The OFDM-based signal structure can be reused for transmitting WUS with a minimum or no impact on the base station (i.e., gNB transmitter) for the waveform generation. For example, the secondary synchronization signal (SSS) and other reference signals along with sequences, such as m-sequence and Zadoff-Chu sequence, can be reused for transmitting WUS. Such sequences have good autocorrelation and cross-correlation properties, making it possible to perform correlation-based detection both in the time and frequency domain with a desirable detection performance. The receiver architecture corresponding to OFDM-based WUS needs to be able to process I/Q samples and extract phase information of the received signal, leading to additional capabilities and enhanced detection performance. The OFDM-based WUR/WUS has the following benefits: 1) compared to OOK-based WUS, the OFDM waveform can reach a target coverage with lower resource consumption, 2) the WUR capable of receiving OFDM waveform can reuse synchronization signals to perform radio resource management (RRM) measurement and synchronization, thus avoiding the introduction of a new always-on synchronization signal, and 3) minimum impact on the base station for generating WUS in coexistence with other transmissions.

### (2) OOK-Based WUS

OOK waveform is a special form of amplitude-shift keying where the information is carried through a sequence of ON (i.e., high power level) and OFF (i.e., low power level) signals. An OOK waveform is attractive for low power and low complexity receivers as it can be detected with an envelope detector in the time domain without the need for power-hungry components such as an accurate oscillator and PLL. While the OOK WUS provides power saving benefits for the WUR, it has less coverage compared to OFDM-based signals for the same resource overhead. Consequently, to reach a target coverage, the system overhead in terms of time-frequency resource consumption is higher than for an OFDM-based WUS. Another consideration is that the OOK waveform needs to be generated using the base stations while ensuring efficient coexistence with OFDM-based transmissions. The two main variants of the OOK waveform generated by an OFDM transmitter are as follows:
Single-bit OOK: within one OFDM symbol, only one ON/OFF OOK segment is transmitted. OOK WUS can be generated by transmitting one bit (0 or 1) per OFDM symbol. In this case, to generate “1” WUS subcarriers have non-zero power (e.g., random QAM symbols) while “0” is generated by having zero-power WUS subcarriers. Single-bit OOK generation of ON/OFF signal is straightforward with minimum impact on the OFDM transmitter.
Multi-bit OOK: to increase the data rate, multiple ON/OFF OOK segments are transmitted within one OFDM symbol. Specifically, the OFDM transmitter should generate a time domain signal that is close to a desired OOK waveform. To ensure a minimum impact on the transmitter and avoid inter-subcarrier interference, the inputs to the inverse fast fourier transform (IFFT) in the frequency domain need to be determined such that the output of the IFFT (in the time domain) represents a desired time domain signal. Compared to single-bit OOK, the generation of the multi-bit OOK waveform is not as straightforward at the base station. Nonetheless, the complexity of waveform generation can be reduced by pre-storing the generated frequency domain samples which are mapped to the WUS sub-carrier segment of IFFT at the base station. Additionally, mapping the generated frequency domain values (before IFFT) to sequences/QAM modulations is beneficial for implementation and it reduces the impact on the base station.

In addition, a harmonized design based on both OOK and OFDM WUS can be considered where the signal can be received by OOK-based WUR and OFDM-based WUR. In this case, OFDM sequences can be additionally modulated on top of the OOK waveform to carry information and provide benefits for devices supporting OFDM-based WUR.

III. Measurement Using MR and/or LP-WUR

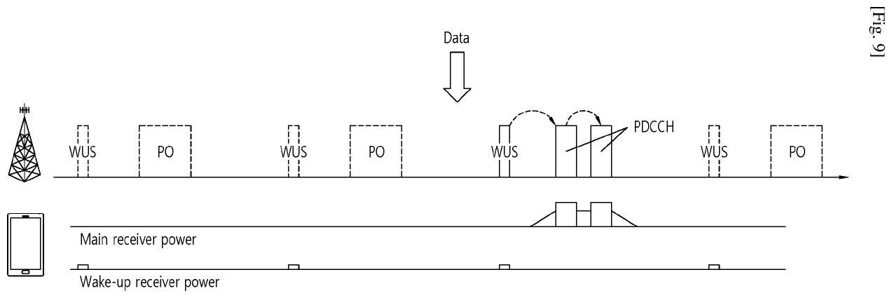

The WUR power saving benefit comes from keeping the MR in a sleep state and turning off the most power-hungry components in the UE. Therefore, a time offset or gap between the UE detection of the WUS and the resumption of UE procedures is required to cater to the start-up time of the MR. In idle/inactive mode, this would typically be before the PO in which the UE monitors downlink control information on PDCCH to see if there is incoming data for the UE. An illustration of WUR monitoring procedure is presented in FIG. 9.

FIG. 9 shows an example of WUR monitoring procedure according to an embodiment of the present disclosure.

Referring to FIG. 9, UE equipped with MR and LP-WUR may monitor WUS in WUS occasions (e.g., configured time offset before POs) using the LP-WUR. The LP-WUR may be in active mode/state in the WUS occasions, while the LP-WUR may be in deep sleep mode/state in other durations.

When the UE detects WUS in a WUS occasion using the LP-WUR, the UE may monitor PDCCH in the associated PO using the MR. The MR may be in active mode/state in the PO associated to the WUS occasion in which the WUS is detected, while the MR may be in an ultra-deep sleep mode/state in other durations.

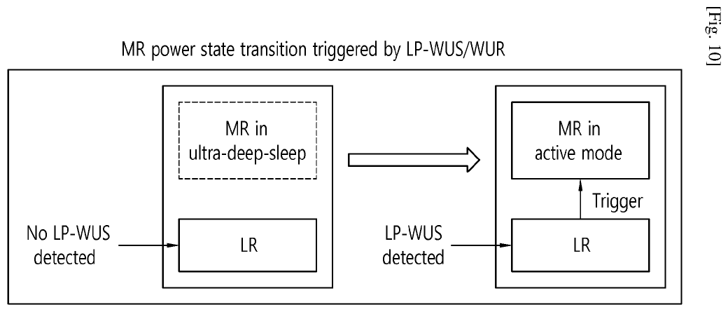

MR power state transmission may be triggered by LP-WUS/WUR, as shown in FIG. 10.

FIG. 10 shows an example of MR power state transmission triggered by LP-WUS/WUR according to an embodiment of the present disclosure.

Referring to FIG. 10, when no LP-WUS is detected by LP-WUR (simply denoted as LR), the MR may be in an ultra-deep sleep mode/state. When LP-WUS is detected by the LP-WUR after some time, the LP-WUR may trigger the MR to be in an active mode/state. That is, MR power state transition from the ultra-deep sleep mode/state to the active mode/state may be triggered by the LP-WUR detecting the LP-WUS.

In the connected mode, the WUS monitoring occasion could be before the DRX on-duration in which the UE monitors PDCCH, or a new separate PDCCH monitoring could be defined for WUR operation. The difference between the two is minor but in general, means a different duty or DRX cycle length and PDCCH monitoring window can be applied for WUR operation, i.e., not dictated by legacy DRX configuration. A short WUR duty-cycle length is beneficial for WUR since it reduces the downlink latency while UE energy consumption can still be kept very low since MR is in a sleep state. If the WUS monitoring occasions are not tied to a legacy procedure, the WUR duty-cycle could be configured freely or WUR operation could even be continuous in time. In this case, the WUR is not switching between active and sleep modes but constantly remains in the active mode. Therefore, due to the higher rate of WUS false alarms, the continuous WUR operation will have a higher energy consumption than duty-cycled WUR operation. The potential benefit of continuous WUR is shorter downlink latency, but this is only the case in practice if the procedure triggered by WUS detection is not restricted to a certain periodicity and hence determines the latency. For example, in idle the latency will be dictated by the periodicity of the physical random access resources.

Meanwhile, UE may support receiving low-power message, where low-power message means that UE can consume relatively lower power to receive the low-power message than conventional message that serves a same or similar purpose as the low-power message. For example, UE may be equipped with Low-Power Radio (LR) and Main Radio (MR), where the LR is used to transmit/receive low power signal/message and the MR is used to transmit/receive main signal/message. For example, in case of paging, RRC-level paging message may be a conventional message and LR-paging message may be a low-power message, and the LR-paging message can provide a same or similar purpose as the conventional paging message.

It is important to keep the coverage of LR message reasonably large as comparable to the coverage of the essential common MR message. To keep the coverage of LR message large enough as necessary, the size of LR message payload should be restricted because the LR payload is transmitted on a common channel.

If the LP-WUS payload as LR message is used for paging purpose, the LP-WUS payload should carry paging ID. The restriction of LP-WUS payload size may introduce a significant reduction of available paging ID length to be included in the LP-WUS payload. As a result, the LP-WUS may not be able to carry a full paging ID but only a (sub) group ID. This would result in that paging monitoring based on the LP-WUS payload would suffer from higher false paging alarm ratio or that even if UE has read LP-WUS payload, UE anyway needs to use main radio to read further paging information e.g., in MR paging message or in PEI, which both reduces power saving gain of employing low-power message.

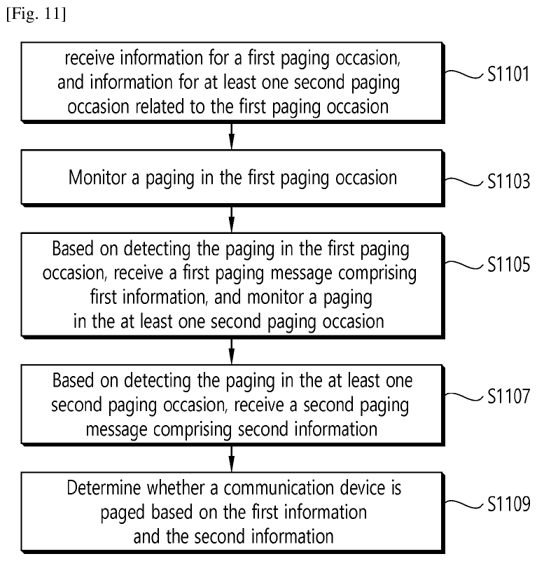

FIG. 11 shows an example of a method performed by a communication device for paging monitoring according to an embodiment of the present disclosure. The method may also be performed by a UE and/or a wireless device.

Referring to FIG. 11, in step S1101, the communication device may receive information for a first paging occasion (e.g., LR P-PO), and information for at least one second paging occasion (e.g., LR S-PO(s)) related to the first paging occasion.

In step S1103, the communication device may monitor a paging in the first paging occasion.

In step S1105, based on detecting the paging in the first paging occasion, the communication device may receive a first paging message comprising first information, and monitor a paging in the at least one second paging occasion.

In step S1107, based on detecting the paging in the at least one second paging occasion, the communication device may receive a second paging message comprising second information.

In step S1109, the communication device may determine whether a communication device is paged based on the first information and the second information.

According to various embodiments, the information for the at least one second paging occasion may comprise at least one of: a number of the at least one second paging occasion; a length of time duration including at least one of a time duration of the first paging occasion, and a time duration of the at least one second paging occasion; an offset of the at least one second paging occasion with respect to the first paging occasion; an interval between consecutive second paging occasions; or a time position of each of the at least one second paging occasion.

According to various embodiments, the communication device may obtain a paging identifier (ID) based on the first information and the second information. The communication device may determine whether the communication device is paged based on the paging ID.

According to various embodiments, the first information may comprise a first sub-ID of the paging ID and the second information may comprise a second sub-ID of the paging ID. The communication device may obtain the paging ID based on combining the first sub-ID and the second sub-ID.

According to various embodiments, the first information and the second information may comprise the paging ID. The communication device may detect a failure of decoding the first paging message. Based on the failure of decoding the first paging message, the communication device may combine the first paging message and the second paging message to obtain a combined paging message. The communication device may obtain the paging ID based on decoding the combined paging message.

According to various embodiments, the communication device may receive information for whether paging messages related to the first paging occasion and the at least one second paging occasion can be combined or not.

According to various embodiments, the paging ID may be a UE-specific paging ID based on a length of the paging ID being same as that of an ID of the communication device for paging. The paging ID may be a UE group-specific paging ID based on a length of the paging ID being shorter than that of the ID of the communication device for paging.

According to various embodiments, based on the UE-specific paging ID being identical to the ID of the communication device for paging, the communication device may determine that the communication device is paged.

According to various embodiments, based on the UE group-specific paging ID being identical to an ID of a UE group to which the communication device belongs, the communication device may monitor a paging in a third paging occasion (e.g., MR PO). Based on detecting the paging in the third paging occasion, the communication device may receive a third paging message. Based on the third paging message including the ID of the communication device for paging, the communication device may determine that the communication device is paged.

According to various embodiments, the first paging occasion and the at least one second paging occasion may be monitored based on a low-power radio (LR). The third paging occasion may be monitored based on a main radio (MR). The LR may be used for transmitting or receiving a signal with lower power than the MR.

According to various embodiments, based on the communication device being paged, the communication device may perform a connection establishment with a network. The connection establishment may comprise at least one of a connection setup for the communication device being in an idle state, or a connection resume for the communication device being in an inactive state.

According to various embodiments, the at least one second paging occasion may comprise a plurality of second paging occasions.

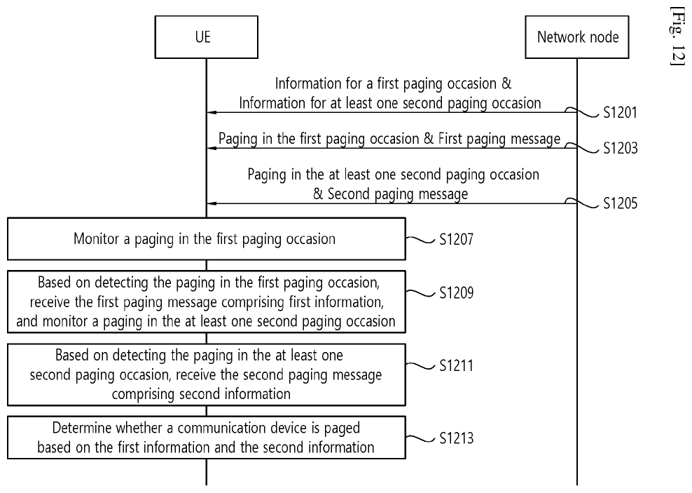

FIG. 12 shows an example of a signal flow between the communication device and a network node for paging monitoring according to an embodiment of the present disclosure. The network node may comprise a BS.

Referring to FIG. 12, in step S1201, the network node may transmit, to a communication device, information for a first paging occasion, and information for at least one second paging occasion related to the first paging occasion.

In step S1203, the network node may transmit a paging in the first paging occasion and a first paging message comprising first information.

In step S1205, the network node may transmit a paging in the at least one second paging occasion and a second paging message comprising second information.

In step S1207, the communication device may monitor the paging in the first paging occasion.

In step S1209, based on detecting the paging in the first paging occasion, the communication device may receive the first paging message comprising the first information and monitor the paging in the at least one second paging occasion.

In step S1211, based on detecting the paging in the at least one second paging occasion, the communication device may receive the second paging message comprising the second information.

In step S1213, the communication device may determine whether the communication device is paged based on the first information and the second information.

Hereinafter, detailed implementations regarding paging monitoring are described.

According to various embodiments, UE may receive N (>1) LR-paging messages (called joint LR-paging messages) to jointly comprehend a paging ID and thus to determine whether the UE is paged by the network. In case the paging ID is a UE ID, the UE may initiate RRC connection establishment procedure. In case the paging ID is a UE group ID, UE may read MR-paging message, and if the MR-paging message include the UE ID for paging, UE may initiate RRC connection establishment procedure.

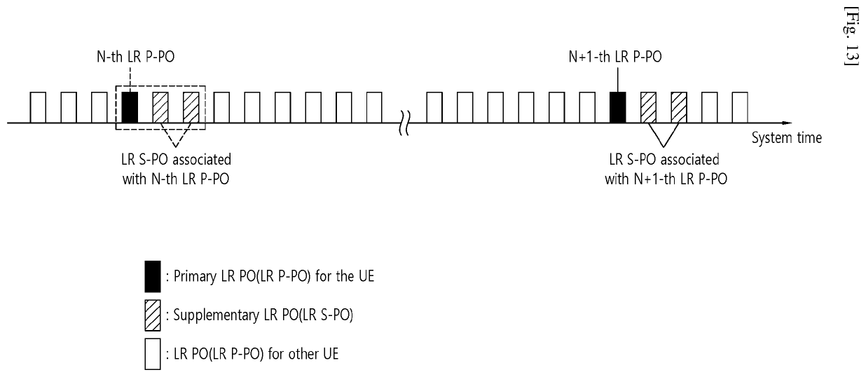

FIG. 13 shows an example of scheduling of joint LR messages according to an embodiment of the present disclosure.

Referring to FIG. 13, joint scheduling of multiple LR-paging messages in one primary LP PO and two supplementary LP POs is shown.

To enable UE to identify the joint LR-paging messages, the concept of LR primary PO (LR P-PO) and LR supplementary PO (LP S-POs) can be considered. Network may provide UE with association information indicating association between LR P-PO and one or more LR S-POs such that UE can identify whether paging ID should be derived based on multiple (joint) LR-paging messages and/or which LR-paging messages should be jointly used for paging ID derivation.

For static scheduling of joint LR-paging messages, network may provide the association information in system information. For dynamic scheduling of joint LR-paging messages, network may provide the association information in LR-paging message (or other LR message) transmitted in the LR P-PO. It is also possible that partial association information that is not subject to dynamic changes is broadcast by system information and other information subject to dynamic changes is transmitted in LR-paging message (or other LR message).

The information may indicate the number N of LR S-POs that are associated with the LR P-PO. The information may indicate the total number M of joint LR POs (at least one LR P-PO and one or multiple LR S-POs to be associated) in one LR paging occasion, where M=N+1.

The information may indicate the length T of time window during which LR S-POs associated with each LR P-PO are transmitted.

The information may indicate the scheduling offset O of the first LR S-PO relative to the timing of the associated LR P-PO.

The information may indicate the scheduling interval P between consecutive LR S-POs. P may be omitted and in this case O can be considered as P.

The information may indicate the time position of each LR S-PO (in terms of e.g., subframe index, slot index and/or symbol index).

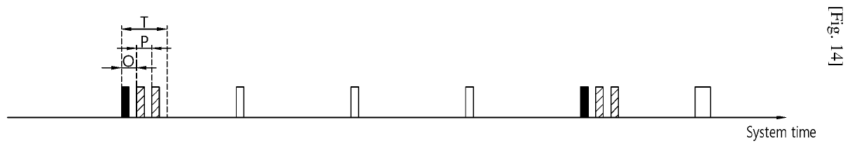

FIG. 14 shows an example of scheduling parameters for LR S-POs according to an embodiment of the present disclosure.

Referring to FIG. 14, the scheduling parameters N, T, O and/or P are shown.

The N refers to the number of LR S-POs that are associated with the LR P-PO. For example, in FIG. 14, N=2.

The T refers to refers to the length of time window during which LR S-POs associated with each LR P-PO are transmitted.

The O refers to the scheduling offset of the first LR S-PO relative to the timing of the associated LR P-PO.

The P refers to the scheduling interval between consecutive LR S-POs.

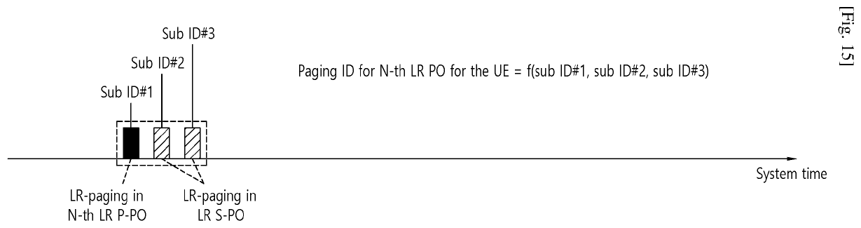

FIG. 15 shows an example of paging ID derivation based on multiple LR-paging message according to an embodiment of the present disclosure.

Referring to FIG. 15, paging ID derivation based on three LR-paging messages is shown.

In some implementations, in the paging ID derivation, each LR-paging message may carry sub-ID, and UE may use joint LR-paging messages to derive a complete paging ID by combining the received sub-IDs included in the joint LR-paging messages.

If UE receives a LR-paging message in LR P-PO that is associated with at least one LR S-PO, the UE may consider to further receive associated LR-paging message(s) in LR S-PO(s) associated with the LR P-PO. UE may store a sub-ID received from each LR-paging message. If UE receives all joint LR-paging messages, UE may derive a paging ID based on the sub-IDs received from the joint LR-paging messages.

For the derivation of the paging ID, the following can be considered:
paging ID can be derived by sequentially concatenating N sub-IDs in a certain order; and/or
Each sub-ID carried by the LR-paging message may indicate hierarchical ID information in a tree-like manner such that the first sub-ID in the first LR-paging PO indicates a highest level UE group, and the next sub-ID in the next LR-paging PO indicates a second-highest level sub-group belonging to the highest level UE group, and the next sub-ID in the next LR-paging PO indicates a third-highest level sub-group belonging to the second-highest level UE sub-group.
Other combining methods can be used.

In some implementations, in the paging ID derivation, each LR-paging message may carry a complete ID and each LR-paging message may be soft-combinable with other LR-paging message of the joint LR-paging messages. Then, if UE attempts to receive a LR-paging message in P-PO but the UE fails to decode the LR-paging message, the UE may continue to receive LR-paging message in following LR S-PO and attempt to decode the LR-paging message by possibly combining the LR-paging messages received in the LR P-PO and LR S-PO. If the UE fails to decode the LR-paging messages, the UE may continue to receive LR-paging message in subsequent LR S-PO and attempt to decode the LR-paging message message by possibly combining the LR-paging message previously received. UE may repeat receiving subsequent LR-paging messages in subsequent LR S-PO until the UE successfully decodes the LR paging message and/or until the time window for LR S-PO is terminated for this paging message. Network may indicate to UE whether the LR-paging messages are soft-combinable or not.

If the derived paging ID has the same length of the UE ID used for paging, the UE may consider that the paging ID is a UE-specific paging ID.

If the derived paging ID has shorter than the length of the UE ID used for paging, the UE may consider that the paging ID is a UE group specific paging ID.

In case the paging ID is a UE specific paging ID:
If the paging ID is identical to the UE ID used for paging of the UE, the UE may initiate RRC connection establishment (e.g., RRC setup in RRC_IDLE or RRC resume in RRC_INACTIVE);
Else, the UE may consider that the UE is not paged by network in the current LR PO.

In case the paging ID is a UE group specific paging ID:
If the paging ID is identical to the UE group ID to which the UE belongs, the UE may read MR-paging message on its MR PO (desirably nearest MR PO of the UE) by using MR. If the MR-paging message includes UE ID used for paging of the UE, the UE may initiate RRC connection establishment (e.g., RRC setup in RRC_IDLE or RRC resume in RRC_INACTIVE).

Else, the UE may consider that the UE is not paged by network in the current LR PO.

UE may fail to receive at least one LR-paging in LR S-PO among the joint POs (i.e., UE successfully receives LR-paging in LR P-PO but fails to receive at least one LR-paging in LR S-PO associated with the LR P-PO). In this case, UE may consider that the UE fails to receive LR paging in the current LR PO and may monitor next earliest LR PO for the UE.

According to various embodiments, UE may receive information indicating a primary paging occasion and at least one supplementary paging occasion associated with the primary paging occasion. The UE may monitor a paging message/paging on the primary paging occasion. The UE may monitor a paging message/paging on the supplementary paging occasion based on a successful reception of the paging message on the primary paging occasion. The UE may derive a paging ID based on received sub-IDs included in the received paging messages. The UE may determine whether the UE is paged based on the derived paging ID. The UE may establish an RRC connection based on the determination that the UE is paged.

For example, the UE may derive paging ID based on multiple sub-IDs.

For example, the UE may derive paging ID based on combining multiple paging messages.

The paging occasion may be a paging occasion for low-power radio (LR), separately operating from main radio (MR), applicable for the UE with LR and MR.

The paging occasion may be a paging occasion for main radio (MR), applicable for UE with MR only as well.

Furthermore, the method in perspective of the UE described in the present disclosure (e.g., in FIG. 11) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving information for a first paging occasion, and information for at least one second paging occasion related to the first paging occasion; monitoring a paging in the first paging occasion; based on detecting the paging in the first paging occasion, receiving a first paging message comprising first information, and monitoring a paging in the at least one second paging occasion; based on detecting the paging in the at least one second paging occasion, receiving a second paging message comprising second information; and determining whether a communication device is paged based on the first information and the second information.

Furthermore, the method in perspective of the UE described in the present disclosure (e.g., in FIG. 11) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving information for a first paging occasion, and information for at least one second paging occasion related to the first paging occasion; monitoring a paging in the first paging occasion; based on detecting the paging in the first paging occasion, receiving a first paging message comprising first information, and monitoring a paging in the at least one second paging occasion; based on detecting the paging in the at least one second paging occasion, receiving a second paging message comprising second information; and determining whether a communication device is paged based on the first information and the second information.

Furthermore, the method in perspective of the UE described in the present disclosure (e.g., in FIG. 11) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., communication device/UE) comprises at least processor, and at least one computer memory operably connectable to the at least one processor. The at least one processor is configured to/adapted to perform operations comprising: receiving information for a first paging occasion, and information for at least one second paging occasion related to the first paging occasion; monitoring a paging in the first paging occasion; based on detecting the paging in the first paging occasion, receiving a first paging message comprising first information, and monitoring a paging in the at least one second paging occasion; based on detecting the paging in the at least one second paging occasion, receiving a second paging message comprising second information; and determining whether a communication device is paged based on the first information and the second information.

Furthermore, the method in perspective of a network node described in the present disclosure (e.g., in FIG. 12) may be performed by the second wireless device 200 shown in FIG. 2. The network node may be related to a serving cell.

More specifically, the network node comprises at least one transceiver, at least processor, and at least one computer memory operably connectable to the at least one processor and storing instructions that, based on being executed by the at least one processor, perform operations.

The operations comprise: transmitting, to a communication device, information for a first paging occasion, and information for at least one second paging occasion related to the first paging occasion; transmitting a paging in the first paging occasion and a first paging message comprising first information; and transmitting a paging in the at least one second paging occasion and a second paging message comprising second information, wherein the communication device is configured to perform operations comprising: monitoring the paging in the first paging occasion; based on detecting the paging in the first paging occasion, receiving the first paging message comprising the first information and monitoring the paging in the at least one second paging occasion; based on detecting the paging in the at least one second paging occasion, receiving the second paging message comprising the second information; and determining whether the communication device is paged based on the first information and the second information.

The present disclosure may have various advantageous effects.

For example, the size of available paging ID can be extended. This would reduce paging false alarm as well as the need of reading MR-paging message, thereby reducing UE power consumption.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving information for a first paging occasion, and information for at least one second paging occasion related to the first paging occasion;
monitoring a paging in the first paging occasion;
based on detecting the paging in the first paging occasion, receiving a first paging message comprising first information, and monitoring a paging in the at least one second paging occasion;
based on detecting the paging in the at least one second paging occasion, receiving a second paging message comprising second information; and
determining whether a communication device is paged based on the first information and the second information.

2. The method of claim 1, wherein the information for the at least one second paging occasion comprises at least one of:
a number of the at least one second paging occasion;
a length of time duration including at least one of a time duration of the first paging occasion, and a time duration of the at least one second paging occasion;
an offset of the at least one second paging occasion with respect to the first paging occasion;
an interval between consecutive second paging occasions; or
a time position of each of the at least one second paging occasion.

3. The method of claim 1, further comprising obtaining a paging identifier (ID) based on the first information and the second information,
wherein the determining of whether the communication device is paged comprises determining whether the communication device is paged based on the paging ID.

4. The method of claim 3, wherein the first information comprises a first sub-ID of the paging ID and the second information comprises a second sub-ID of the paging ID, and
wherein the obtaining of the paging ID comprises obtaining the paging ID based on combining the first sub-ID and the second sub-ID.

5. The method of claim 3, wherein the first information and the second information comprise the paging ID, and
wherein the obtaining of the paging ID comprises:
detecting a failure of decoding the first paging message;
based on the failure of decoding the first paging message, combining the first paging message and the second paging message to obtain a combined paging message; and
obtaining the paging ID based on decoding the combined paging message.

6. The method of claim 5, further comprising receiving information for whether paging messages related to the first paging occasion and the at least one second paging occasion can be combined or not.

7. The method of claim 3, wherein the paging ID is a UE-specific paging ID based on a length of the paging ID being same as that of an ID of the communication device for paging, and
wherein the paging ID is a UE group-specific paging ID based on a length of the paging ID being shorter than that of the ID of the communication device for paging.

8. The method of claim 7, wherein the determining of whether the communication device is paged comprises:
based on the UE-specific paging ID being identical to the ID of the communication device for paging, determining that the communication device is paged.

9. The method of claim 7, wherein the determining of whether the communication device is paged comprises:
based on the UE group-specific paging ID being identical to an ID of a UE group to which the communication device belongs, monitoring a paging in a third paging occasion;
based on detecting the paging in the third paging occasion, receiving a third paging message; and
based on the third paging message including the ID of the communication device for paging, determining that the communication device is paged.

10. The method of claim 9, wherein the first paging occasion and the at least one second paging occasion are monitored based on a low-power radio (LR),
wherein the third paging occasion is monitored based on a main radio (MR), and
wherein the LR is used for transmitting or receiving a signal with lower power than the MR.

11. The method of claim 1, further comprising:
based on the communication device being paged, performing a connection establishment with a network,
wherein the connection establishment comprises at least one of a connection setup for the communication device being in an idle state, or a connection resume for the communication device being in an inactive state.

12. The method of claim 1, wherein the at least one second paging occasion comprises a plurality of second paging occasions.

13. The method of claim 1, wherein the method is performed by the communication device in communication with at least one of a mobile device, a network, or autonomous vehicles.

14. A communication device comprising:
at least one transceiver;
at least one processor; and
at least one memory operatively coupled to the at least one processor and storing instructions that, based on being executed by the at least one processor, perform operations comprising:
receiving information for a first paging occasion, and information for at least one second paging occasion related to the first paging occasion;
monitoring a paging in the first paging occasion;
based on detecting the paging in the first paging occasion, receiving a first paging message comprising first information, and monitoring a paging in the at least one second paging occasion;
based on detecting the paging in the at least one second paging occasion, receiving a second paging message comprising second information; and
determining whether the communication device is paged based on the first information and the second information.

15-17. (canceled)

18. A network node comprising:
at least one transceiver;
at least one processor; and
at least one memory operatively coupled to the at least one processor and storing instructions that, based on being executed by the at least one processor, perform operations comprising:
transmitting, to a communication device, information for a first paging occasion, and information for at least one second paging occasion related to the first paging occasion;
transmitting a paging in the first paging occasion and a first paging message comprising first information; and
transmitting a paging in the at least one second paging occasion and a second paging message comprising second information,
wherein the communication device is configured to perform operations comprising:
monitoring the paging in the first paging occasion;
based on detecting the paging in the first paging occasion, receiving the first paging message comprising the first information and monitoring the paging in the at least one second paging occasion;
based on detecting the paging in the at least one second paging occasion, receiving the second paging message comprising the second information; and
determining whether the communication device is paged based on the first information and the second information.
